(19) United States
(12) Patent Application Publication
(10) Pub. No.: US 2014/0229942 A1
(43) Pub. Date: Aug. 14, 2014

(54) ISOLATED GUEST CREATION IN A VIRTUALIZED COMPUTING SYSTEM

(71) Applicants: Willard Monty Wiseman, Tigard, OR (US); Kirk Brannock, Hillsboro, OR (US); Brian Delgado, Beaverton, OR (US); Jiewen Jacques Yao, Shanghai (CN); Vincent Zimmer, Federal Way, WA (US)

(72) Inventors: Willard Monty Wiseman, Tigard, OR (US); Kirk Brannock, Hillsboro, OR (US); Brian Delgado, Beaverton, OR (US); Jiewen Jacques Yao, Shanghai (CN); Vincent Zimmer, Federal Way, WA (US)

(21) Appl. No.: 13/993,899

(22) PCT Filed: Sep. 21, 2012
(86) PCT No.: PCT/CN2012/081721

§ 371 Date: Jun. 13, 2013

(51) Int. Cl. G06F 21/53; G06F 9/455

(52) U.S. Cl. CPC G06F 21/53; G06F 9/45533
USPC 718/1

(57) ABSTRACT

This disclosure is directed to isolated guest creation in a virtualized computing system. A memory in a computing device may be divided into isolated execution environments, allowing some software (e.g., guests) to be isolated in a high privilege execution environment. A virtual machine manager (VMM) of a low privilege execution environment may issue commands to a VMM of the high privilege execution environment to, for example, cause a guest loaded in the low privileged execution environment to be placed into the high privilege execution environment, to interact with the guest in the high privilege execution environment, to cause the guest to be removed from the high privilege execution environment, etc. The guest may include attributes configured to control guest behavior such as, for example, when to perform activities, how to respond to stop commands received from the VMM of the high privilege execution environment, etc.

### TECHNICAL FIELD

The present disclosure relates to computer security, and more particularly, to systems for allowing lower privilege entities to place guests into higher privilege execution environments.

### BACKGROUND

Current security schemes in computing devices may attempt to protect software critical to device operation through segregation. For example, in a virtual machine environment such as, for example, the Virtual Technology (VT) functionality incorporated on many processors offered by the Intel Corporation, one or more machine managers may control virtual machines operating in different operational environments. For example, VT defines a primary monitor mode wherein virtual machine managers (VMM) or hypervisors (HV) are able to deprivilege guest operating systems (OS). Similarly, VT also provides a system management mode transfer monitor (STM) that can deprivilege the SMI handler such that it runs as a guest of the STM in system management mode (SMM). SMM may initiate with the current state of the processor being saved and all other processes being stopped. High privilege operations may then be performed, such as, for example, debugging, hardware management, security functions, emulation, etc., followed by the computing device resuming operation based on the saved state. Upon the occurrence of a system mode interrupt (SMI), the computing device may enter SMM.

In some instances the VMM or HV may be provided by a third party vendor. In such an instance, it is a challenge to verify whether these programs have been changed or even corrupted by another program (e.g., malware). Current systems possess the ability to “measure” programs prior to loading, which through hashing may provide some indication of the identity/version of the software. However, even with measurement there is no assurance that these high privilege programs will not attempt nefarious transactions. Peer monitoring by a program in the normal execution environment may be compromised because the VMM or HV maintains the highest privilege. A separate memory space exists that is accessible during SMM (e.g., SMRAM). The SMRAM maintains its own VMM called the SMI transfer monitor (STM). While the SMRAM may provide a secure operational environment that could house various programs that would benefit from the isolation of the SMRAM, current STM architecture only allows for a BIOS SMM guest and an SMI guest such as a Measured Launch Environment (MLE) SMM guest.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example device configured for isolated guest creation in a virtualized computing system in accordance with at least one embodiment of the present disclosure;

FIG. 2 illustrates an example configuration for isolated guests in accordance with at least one embodiment of the present disclosure;

FIG. 3 illustrates example commands and attributes in accordance with at least one embodiment of the present disclosure;

FIG. 4 illustrates an example of a trusted peer monitor and integrity check in accordance with at least one embodiment of the present disclosure;

FIG. 5 illustrates a flowchart of example operations for isolated guest creation in a virtualized computing system in accordance with at least one embodiment of the present disclosure; and

FIG. 6 illustrates a flowchart of example operations for attribute handling in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to isolated guest creation in a virtualized computing system. A memory in a computing device may be divided into isolated execution environments, allowing some software (e.g., guests) to be isolated in a high privilege execution environment. A virtual machine manager of a low privilege execution environment (e.g., MLE) may be configured to issue commands to a VMM of the high privilege execution environment (e.g., STM) to, for example, cause a guest loaded in the low privileged execution environment to be placed into the high privilege execution environment, to interact with the guest in the high privilege execution environment, to cause the guest to be removed from the high privilege execution environment, etc. The guest may include attributes configured to control guest behavior such as, for example, when to perform activities, how to respond to stop commands received from the MLE, etc.

In one embodiment, a device may include a memory module and a processing module. The memory module may be configured to include a high privilege execution environment and a low privilege execution environment. In instances when the processing module is equipped with VT, the high privilege execution space may correspond to a SMRAM accessible during SMM. The processing module may be configured to, for example, execute a low privilege manager (LP manager) configured to control operation of the low privilege execution environment. The LP manager may also be configured to, for example, cause a high privilege manager (HP manager) configured to control operation for the high privilege execution environment to place at least one guest into the high privilege execution environment.

In an example VT-based implementation, the LP manager may be an MLE and the HP manager may be an STM. The MLE may be configured to initially obtain the at least one guest from at least one of the BIOS image (e.g., Unified Extensible Firmware Interface (UEFI) code), another device via a network connection or a data storage component in the device (e.g., Flash, disk drive, etc.). The guest may be an SMM guest other than the currently defined BIOS SMM guest or SMI guest (e.g., the MLE). The MLE may then issue a command to the STM to load the at least one guest from the low privilege execution environment into the high privilege execution environment. The MLE may still interact with the at least one guest via a command to the STM, and another command to the STM may tear down and remove the at least one guest from the high privilege execution environment (e.g., to make space available in the SMRAM).

In one embodiment, the at least one guest may be configured to include a header, body, signature and attributes (e.g., SMMGuest Attributes). The signature may allow the MLE and/or the STM to verify that the guest is legal (e.g., not malware and/or licensed). The attributes may contain at least one bit configured to control the behavior of the at least one guest. For example, a bit may be set in the attributes to indicate that the at least one guest should continue to perform an activity periodically (e.g., to prevent a corrupted MLE from discontinuing periodic peer-to-peer monitoring functionality). Another bit in the attributes that may be employed alone, or in conjunction with the above, may indicate to the at least one guest that commands received from the STM instructing the at least one guest to discontinue operation should be ignored (e.g., to prevent a corrupted MLE from discontinuing peer-to-peer monitoring functionality).

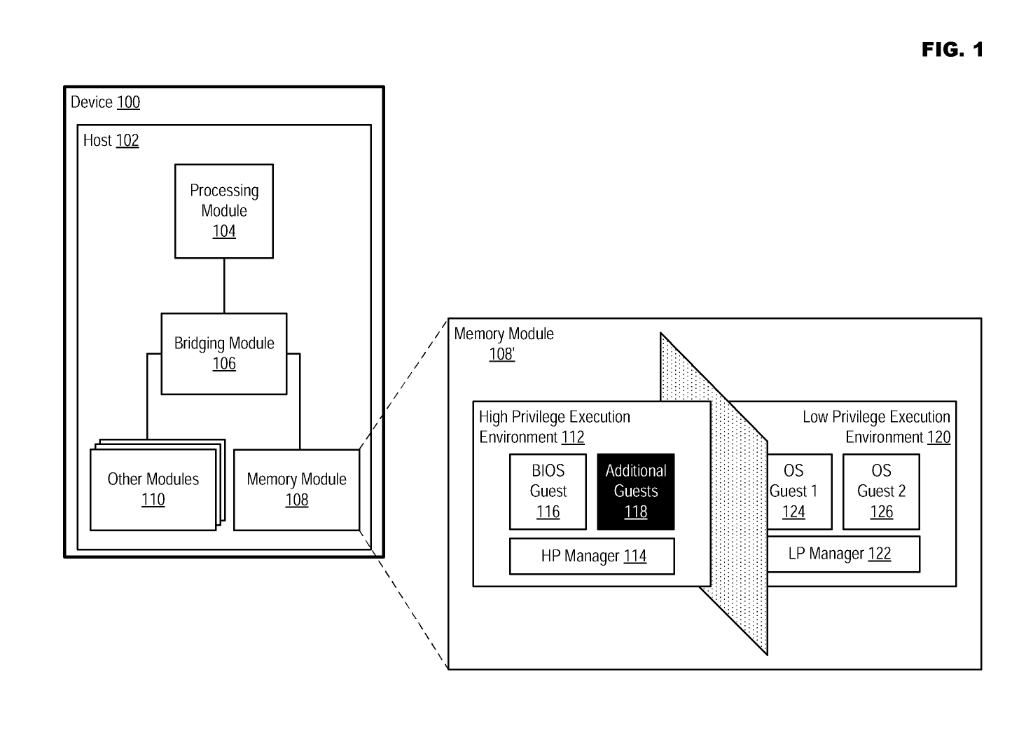

FIG. 1 illustrates an example device configured for isolated guest creation in a virtualized computing system in accordance with at least one embodiment of the present disclosure. Some examples of device 100 may include, but are not limited to, a mobile communication device such as a cellular handset or smartphone based on the Android® operating system (OS), iOS®, Blackberry® OS, Palm® OS, Symbian® OS, etc., a mobile computing device such as a tablet computer like an iPad®, Galaxy Tab®, Kindle Fire®, etc., an Ultrabook® including a low-power chipset manufactured by Intel Corporation, a netbook, a notebook computer, a laptop computer, etc., a typically stationary computing device such as a desktop computer, server computer, etc.

Example device 100 may comprise, for example, host 102 configured to handle baseline operations for device 100. Host 102 may include, for example, processing module 104, bridging module 106, memory module 108 and other modules 110. Processing module 102 may comprise one or more processors situated in separate components, or alternatively, one or more processing cores embodied in a single integrated circuit (IC) arranged, for example, in a System-on-a-Chip (SOC) configuration. Example processors may include various x86-based microprocessors available from the Intel Corporation including those in the Pentium, Xeon, Itanium, Celeron, Atom, Core i-series product families. Bridging module 106 may include circuitry configured to support processing module 104. Example circuitry may include interface/bridging chipsets (e.g., a group of ICs) such as the Northbridge, Southbridge, or subsequently released bridging chipsets from Intel Corporation, that may be configured to handle communications between processing module 104, memory module 108 and other modules 110 communicating using various buses in device 100′. For example, bridging module 106 may be configured to handle signaling between the various modules by converting from one type/speed of communication to another, and may be further configured to be compatible with a variety of different devices to allow for different system implementations, upgrades, etc. Some of the functionality of bridging module 106 may also be incorporated into processing module 104, memory module 108 or other modules 110.

Processing module 104 may be configured to execute instructions. Instructions may include program code configured to cause processing module 104 to perform activities such as, but not limited to, reading data, writing data, processing data, formulating data, converting data, transforming data, etc. Information, including instructions, data, etc., may be stored in memory module 204. Memory module 108 may comprise random access memory (RAM) or read-only memory (ROM) in a fixed or removable format. RAM may include memory configured to hold information during the operation of device 100′ such as, for example, static RAM (SRAM) or Dynamic RAM (DRAM). ROM may include memories such as computing device bios memory configured to provide instructions when device 100′ activates, programmable memories such as electronic programmable ROMs, (EPROMS), Flash, etc. Other fixed and/or removable memory may include magnetic memories such as floppy disks, hard drives, etc., electronic memories such as solid state Flash memory (e.g., eMMC, etc.), removable memory cards or sticks (e.g., USB, uSD, etc.), optical memories such as compact disc-based ROM (CD-ROM), holographic, etc.

Other modules 110 may include modules directed to supporting other functionality within device 100 that, while useful or possibly necessary to operation, are not essential to the present disclosure. Other modules 110 may include, for example, modules configured to supply power to device 100, modules configured to support wired and/or wireless communications in device 100, modules configured to provide user interface features in device 100, modules configured to support specialized functionality, etc. The composition of other modules 110 may be variable depending upon, for example, form factor, the use for which device 100 has been configured, etc.

An embodiment of memory module 108 consistent with the present disclosure is shown at 108′. Memory module 108′ may include, for example, high privilege execution environment 112 and low privilege execution environment 120. Software running in high privilege execution environment 112 may be able to affect the operation of other software in device 100 (e.g., may be able to read, write and/or execute software in low privilege execution environment 120), but software running in low privilege execution environment 120 cannot affect any software running in high privilege execution environment 112. High privilege execution environment 112 may include, for example, HP manager 114 configured to manage the operation of BIOS guest 116 and additional guests 118. Low privilege execution environment 120 may include LP manager 122 configured to manage the operation of OS guest 1 124 and OS guest 2 126. While only two OS guests 124 and 126 are shown, embodiments consistent with the present disclosure are not limited only to two guests.

In at least one embodiment, activities in high privilege execution environment 112 may only occur when device 100 enters a particular mode. In this mode, all other processing activity may be discontinued in processing module 104, the current context of processing module 104 may be saved, and then any operations related to high privilege execution environment 112 may be carried out prior to returning to normal operation in device 100. This mode may be configured by HP manager 114. LP manager 122 may have a guest in high privilege execution environment 112, and thus, may use this guest to cause HP manager 114 to perform various actions. For example, software may be loaded into low privilege execution environment 120 (e.g., from the BIOS image during boot, from another device via a network connection, from Flash, disk drive, etc.), and LP manager 122 may then transmit an interrupt causing HP manager 114 to load the software as an additional guest 118. LP manager 122 may issue further interrupts to HP manager 114 to cause additional guest 118 to perform actions or to be removed from high privilege environment 112 (e.g., to make space for other software in high privilege execution environment 112).

Additional guests 118 may comprise any software, but given space limitations that may exist in high privilege execution environment 112, may be especially suitable for programs that would benefit from being isolated from other influences in device 100. For example, additional guests 118 might include a monitor configured to determine if LP manager 122 is safe (e.g., free of viruses, corruption, etc.). Digital rights management (DRM) is another good application for additional guests 118. The isolation provided by high privilege execution environment 112 may bolster, or even replace, existing tamper-resistant software methods currently used as protection for the “black box” code configured to enforce licensing and content protection in device 100. Under the protection of HP manager 114, the DRM black box software may enjoy isolation and possibly even attestation (e.g., the code may be “measured” at launch to confirm its identity). Other examples of additional guests 118 may also include software configured for providing backup services, remediation, manageability, general anti-virus scanning, streaming, etc.

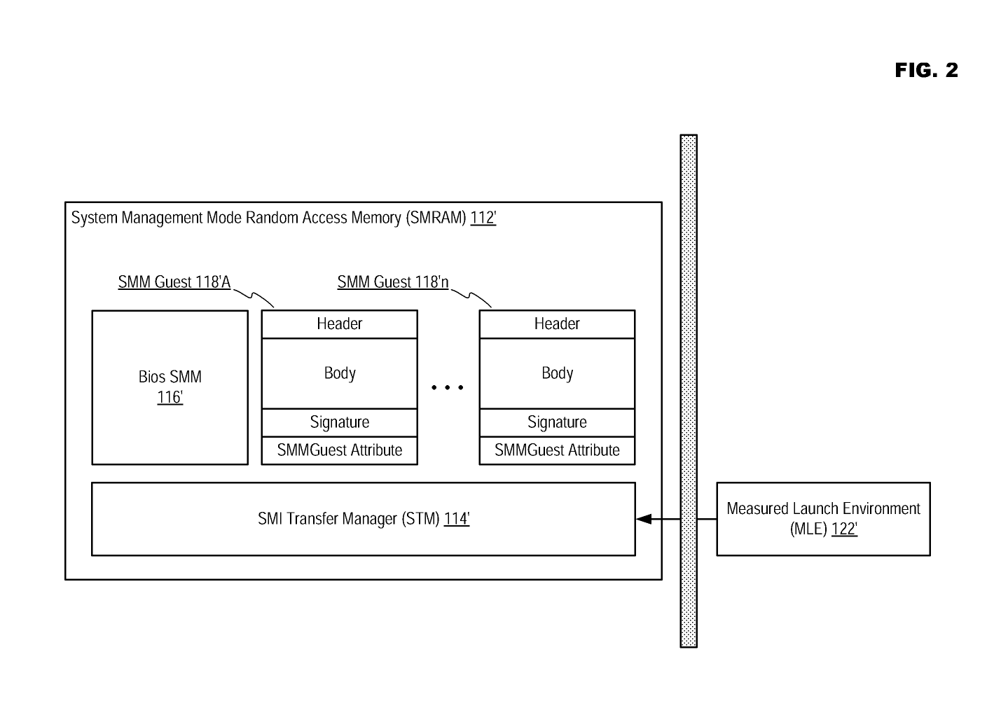

FIG. 2 illustrates an example configuration for isolated guests in accordance with at least one embodiment of the present disclosure. It is important to note that some of the embodiments disclosed herein may be explained using terminology associated with virtualization technology (VT) currently available in many microprocessors manufactured by the Intel Corporation. VT is functionality allowing more than one virtual machine to simultaneously share access to physical processing resources in a safe and efficient manner. While the present disclosure discusses some embodiments using these terms, the use of these terms is only for the sake of explanation herein. Implementations consistent with the present disclosure are not limited to using this technology. For example, other hardware (e.g., microprocessors) and/or software offering similar features may also be employed in a manner consistent with the various embodiments as disclosed herein.

In the example implementation of FIG. 2, high privilege execution environment 112 is shown as system management mode random access memory (SMRAM) 112′ in accordance with current VT architecture. STM 114′ may be configured to manage the operation of BIOS SMM guest 116′ and SMM Guests 118′ 1-n. In one embodiment, LP manager 122 (e.g., MLE 122′ in FIG. 2) may cause STM 114′ to place SMM guests 118′ 1-n in SMRAM 112′. Alternatively, the BIOS (e.g., UEFI firmware) may cause additional SMM guests 118′ 1-n to be created during boot. Regardless, STM 114′ can put each SMM guest 118′ 1-n into a “sandbox” environment (e.g., an isolated execution environment) to make sure each SMM guest 118′ 1-n doesn't destroy the secure boundary which is created during boot-up. For example, STM 114′ may mediate all memory and I/O accesses of SMM guests 118′ 1-n to ensure that the security claims of peer containers (e.g., other guests in SMRAM 112′) and MLE 122′ are not violated. Since only BIOS SMM 116′ and MLE 122′ may interact with STM 114′, in one embodiment SMM guests 118′ 1-n may be created by MLE 122′. For example, SMM Guest binary code may be loaded to DRAM from the BIOS image during boot, from another device via a network connection, from a data storage component in device 100 (e.g., Flash, disk drive, etc.). MLE 122′ may then use certain VMCALL commands to cause STM 114′ to place the SMM guest that was previously loaded into DRAM into SMRAM 112′, creating SMM Guests 118′ 1-n. Alternately, the BIOS (e.g., UEFI firmware) may issue certain VMCALL commands to the STM 114′ to cause SMM guests 118′ 1-n to be created. The code used to create SMM guests 118′ 1-n may be obtained from the UEFI firmware, the EFI System Partition (ESP), across a network, etc.

SMRAM 112′ now houses three types of components: STM 114′, BIOS SMM 116′ and SMM Guests 118′ 1-n. Each component may execute in an isolated environment. The number of SMM Guests 118′ 1-n may depend on, for example, the size of SMRAM 112′. In instances where, for example, the amount of space in SMRAM 112′ is limited, MLE 122′ can use another special VMCALL command to cause STM 114′ to tear down the environment (e.g., to remove at least one SMM Guest 118′ 1-n) and free space in SMRAM 112′. As a result, the launching and teardown of SMM Guests 118′ 1-n may occur either at OS runtime or at the request of MLE 122′.

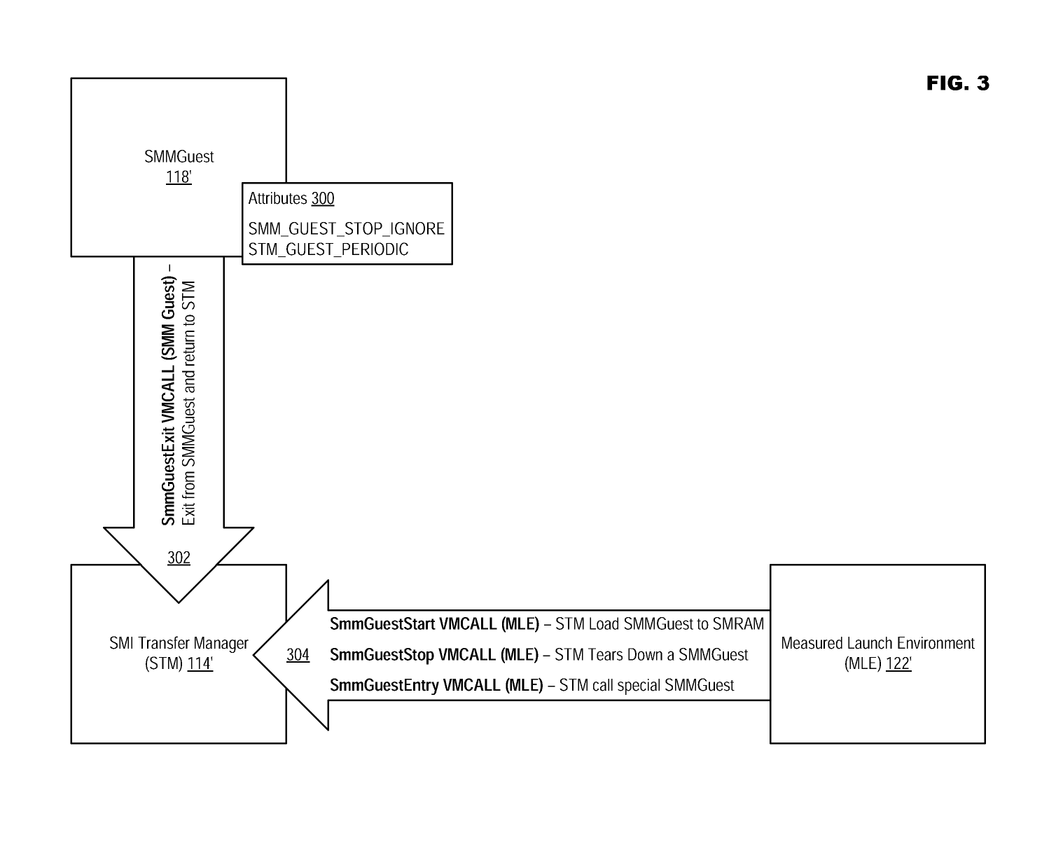

The structure of SMM Guests 118′ 1-n may include some elements of the STM image format currently defined in the STM specification. For example, at least a header and body may be included, the header and body comprising information such as entrypoint, stack, gdt, segment, pagetable, imagesize, heapsize, etc. In one embodiment, new elements including signature and SMMGuest attributes are also added as shown in FIG. 2. Adding a signature to the structure of SMM Guests 118′ 1-n creates a signed guest image, allowing STM 114′ to verify whether SMM Guest 118′ 1-n are legal (e.g., licensed, not malware, etc.) based on the signature. In the same or a different embodiment, an existing element “STM Feature” may be redefined to be SMM Guest Attribute. The SMM Guest attribute may be used to inform STM 114′ of special requirements for the particular SMM Guest 118′, such as required permissions. SMM attributes may also include indicators (e.g., bits) set to control guest behavior, which will be discussed further in FIG. 3.

FIG. 3 illustrates example commands and attributes in accordance with at least one embodiment of the present disclosure. STM 114′ may be configured to interact with MLE 122′ and at least one SMM Guest 118′. In at least one embodiment, commands may be issued from MLE 122′ and SMM Guest 118′, the commands causing STM 114′ to perform various functions. Example commands are disclosed at 304 for causing STM 114′ to perform functions related to SMM Guest 118′. “SMM GuestStart VMCALL (MLE)” may cause STM 114′ to load SMM Guest 118′ to SMRAM 112′. In instances where STM 114′ is also configured to measure SMM Guest 118′, then STM 114′ may also return identification information for SMM Guest 118′ to MLE 122′. “SmmGuestStop VMCALL (MLE)” may cause STM 114′ to tear down SMM Guest 118′ (e.g., remove SMM Guest 118′ from SMRAM 112′). “SmmGuestEntry VMCALL (MLE)” is a command to STM 114′ to call a special SMM Guest 118′. This VMCALL may allow MLE 122′ to interact with SMM Guest 118′. For example, MLE 122′ may utilize the SmmGuestEntry VMCALL to cause a particular SMM Guest 118′ configured for monitoring (e.g., antivirus and/or antimalware) to check the integrity of memory module 108 (e.g., MleBase, MleSize). In this instance, MLE 122′ may provide parameters to SMM Guest 118′ such as, for example, a general purpose register (e.g., EBX/ECX) to a whole parameter (e.g., MleBase, MleSize).

Commands may also be sent from SMM Guest 118′ to STM 114′ as shown at 302. For example, “SmmGuestExit VMCALL (SMMGuest)” may exit from activities being performed in SMM Guest 118′ and may return to STM 114′. When actions are required by SMM Guest 118′ during SMM, MLE 122′ can issue a SmmGuestEntry VMCALL command to cause SMM Guest 118′ to perform the actions. Alternatively, MLE 122′ can let SMM Guest 118′ register a periodic SmmGuestEntry with STM 114′, allowing SmmGuestEntry( ) to be invoked automatically when STM 114′ receives a periodic event. For S™ binary, special attributes bits may be introduced, as shown at 300, to protect the integrity of SMM Guest 118′. For example, if SMM Guest 118′ is configured as an MLE monitor, a potential weakness may exist given the high privilege that is assigned to MLE 122′ in the current STM specification. For example, a compromised MLE may be able to bring down the MLE monitor using SmmGuestStop( ) or by avoiding the triggering of a measurement by not calling SmmGuestEntry( ). To avoid the SmmGuestStop( ) call being used to defeat protection in device 100, a SMM_GUEST_STOP_IGNORE bit may be set in SMM Guest 118′ to cause STM 114′ to ignore SmmGuestStop( ) calls received from MLE 122′ (e.g., at least any SmmGuestStop( ) calls that are directed to the particular SMM Guest 118′ in which the stop ignore bit is set). In the alternative scenario, a SMM_GUEST_PERIODIC bit may be set in SMM Guest 118′ to cause STM 114′ to configure SMM Guest 118′ for periodic operation (e.g., STM 114′ may automatically issue periodic SmmGuestEntry( ) calls to any SMM Guest 118′ in which the periodic bit is set). When the periodic bit is set, SMM Guest 118′ can report heartbeat message to, for example, a network via a standard network interface card (NIC) or alert devices using alert standard format (ASF) for active management technology (AMT) created by the Intel Corporation. When SMM Guest 118′ requires access to a hardware resource, MLE 122′ may provide an SmmGuestResourceList when it invokes SMM Guest 118′ via SmmGuestStart( ). For isolation purposes, STM 114′ may only allow SMM Guest 118′ to access MLE 122′ and/or may deny access to STM 114′, Bios SMM Guest 116′ and/or any other SMM Guests 118′.

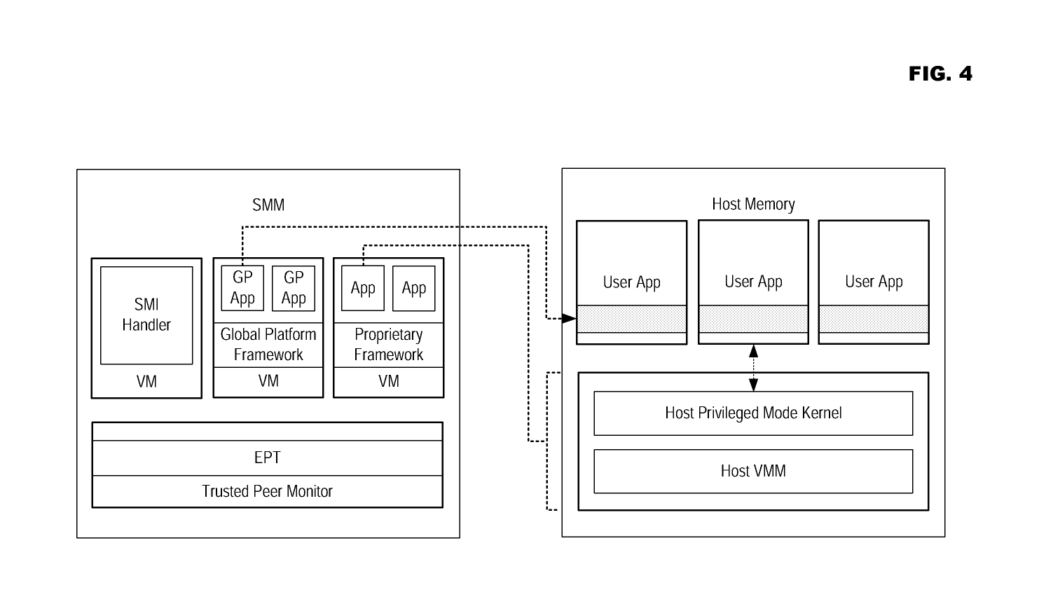

FIG. 4 illustrates an example of a trusted peer monitor and integrity check in accordance with at least one embodiment of the present disclosure. In one embodiment, STM 114′ may be configured as a trusted peer monitor with an extended page table (EPT) and at least one SMM Guest 118′ (e.g., “App” in the Proprietary Framework illustrated in FIG. 4) may be configured as an integrity checker for MLE 122′ (e.g., including hostprivilegedkernel, eventrusteduserapp). The integrity checker may be configured to monitor the kernel and/or Host VMM. While not shown, in some instance the SMI handler may be given partial access to the host memory. In addition, the trusted peer monitor may open communication buffers for the host and trusted apps to communicate in the Global Platform Framework. For example, a private channel (e.g., likesharememory) may be opened to support communication between SMM guest 118′ and MLE 122′, hostkernel and/or trustedapp.

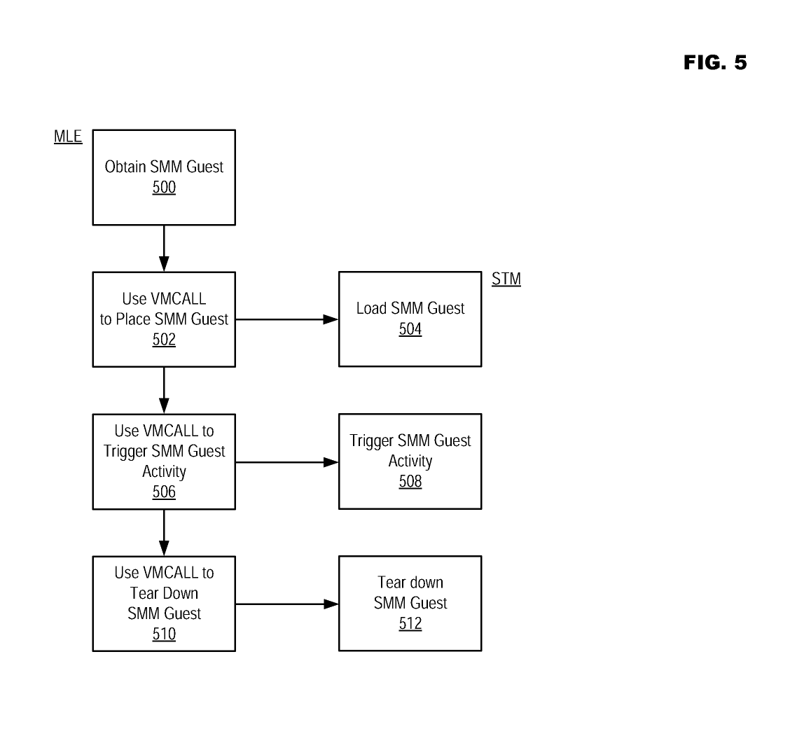

FIG. 5 illustrates a flowchart of example operations for isolated guest creation in a virtualized computing system in accordance with at least one embodiment of the present disclosure. In FIG. 5, operations 500, 502, 506 and 510 may be performed by an MLE in a device, while operations 504, 508 and 512 may be performed by an STM in the device.

In operation 500, an MLE may obtain an SMM Guest and place it into a low privilege execution environment in the device. For example, the SMM guest may be loaded by the BIOS image during boot, may be retrieved from another device via a network connection or from a data storage component in the device (e.g., Flash, disk drive, etc.). In operation 502, the MLE may issue a VMCALL command to place the SMM guest into a high privilege execution environment. For example, the MLE may issue the SmmGuestStart VMCALL (MLE) command, which may cause the STM to place the SMM Guest into the high privilege execution environment in operation 504. The MLE may then use another VMCALL command to trigger activity (e.g., monitoring/antimalware functionality, licensing/copyright protection, etc.) in the SMM Guest in operation 506. For example, the MLE may issue the SmmGuestEntry VMCALL (MLE), which may cause the STM to trigger the desired activity in operation 508. Upon determining that the SMM Guest is no longer needed, the MLE may use a VMCALL command to cause the SMM guest to be removed from the high privilege execution environment in operation 510. For example, the MLE may issue the SmmGuestStop VMCALL (MLE), which may cause the STM to tear down the SMM Guest in operation 512.

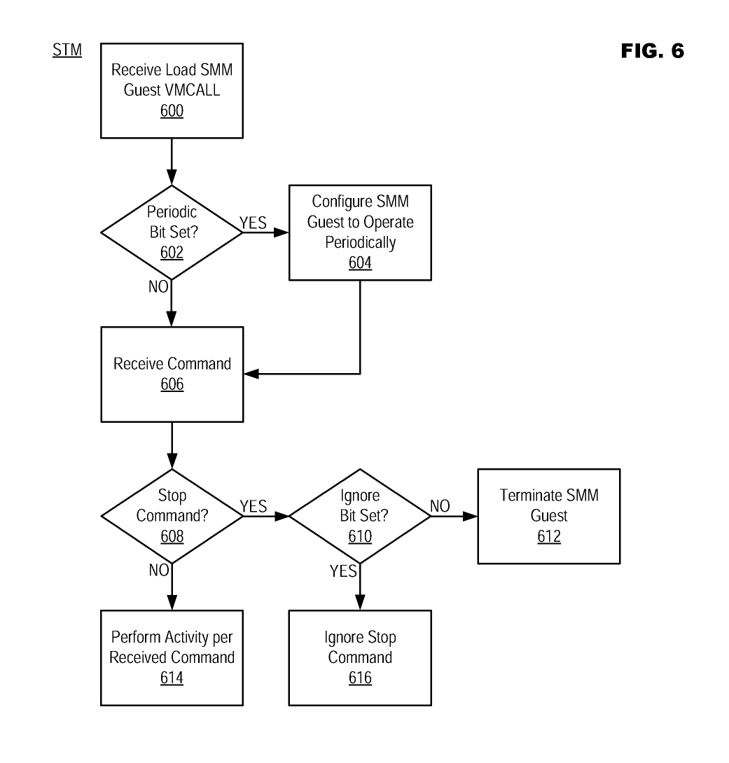

FIG. 6 illustrates a flowchart of example operations for attribute handling in accordance with at least one embodiment of the present disclosure. Initially, the STM may receive a Load SMM Guest call in operation 600. A determination may then be made in operation 602 as to whether a periodic indicator bit is set in the SMM Guest. If in operation 602 it is determined that the periodic bit is set in the SMM Guest, then in operation 604 the STM may configure the SMM Guest in which the periodic bit is set to perform a certain activity (e.g., monitoring/antimalware functionality, licensing/copyright protection, etc.) on a periodic basis.

Following operation 604, or if in operation 602 it is determined that the periodic bit was not set, a command may be received in the STM (e.g., from an MLE in the device) in operation 606. A determination may then be made in operation 608 as to whether the command is a stop command (e.g., instructing the STM to terminate the SMM Guest). If in operation 608 it is determined that the command is a stop command, then in operation 610 a further determination may be made as to whether a stop ignore indicator bit is set in the SMM Guest. If in operation 610 it is determined that the stop ignore indicator bit is not set, then in operation 612 the STM may proceed to terminate the SMM Guest. If in operation 610 it is determined that the stop ignore bit is set, then in operation 616 the STM may ignore the stop command. Returning to operation 608, if it is determined that a stop command was not received, then in operation 614 the STM may perform the activity being instructed in the command received in operation 606.

While FIGS. 5 and 6 illustrate various operations according to different embodiment, it is to be understood that not all of the operations depicted in FIGS. 5 and 6 are necessary for other embodiments. Indeed, it is fully contemplated herein that in other embodiments of the present disclosure, the operations depicted in FIGS. 5 and 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), Flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure is directed to isolated guest creation in a virtualized computing system. A memory in a computing device may be divided into isolated execution environments, allowing some software (e.g., guests) to be isolated in a high privilege execution environment. A virtual machine manager (VMM) of a low privilege execution environment may issue commands to a VMM of the high privilege execution environment to, for example, cause a guest loaded in the low privileged execution environment to be placed into the high privilege execution environment, to interact with the guest in the high privilege execution environment, to cause the guest to be removed from the high privilege execution environment, etc. The guest may include attributes configured to control guest behavior such as, for example, when to perform activities, how to respond to stop commands received from the VMM of the high privilege execution environment, etc.

The following examples pertain to further embodiments. In one example embodiment there is provided a device. The device may include a memory module configured to include a high privilege execution environment and a low privilege execution environment, and a processing module configured to execute a low privilege manager for the low privilege execution environment, the low privilege manager being configured to cause a high privilege manager in the high privilege execution environment to place at least one guest into the high privilege execution environment.

The above example device may be further configured, wherein placing the at least one guest comprises the low privilege manager being further configured to initially load the at least one guest into the low privilege execution environment by obtaining the at least one guest from at least one of a BIOS image loaded into the device when activated, another device via a network connection or a data storage component in the memory module. In this configuration, the example device may be further configured, wherein placing the at least one guest comprises the low privilege manager being further configured to issue a command to the high privilege manager to load the at least one guest from the low privilege execution environment into the high privilege execution environment.

The above example device may further comprise the low privilege manager being further configured to interact with the at least one guest by issuing a command to the high privilege manager.

The above example device may further comprise the low privilege manager being further configured to cause the at least one guest to be removed from the high privilege execution environment by issuing a command to the high privilege manager.

The above example device may be further configured, wherein the at least one guest is configured to include a header, body, signature and attributes. In this configuration, the example device may be further configured, wherein the attributes include at least one bit configured to cause the at least one guest to at least one of ignore stop commands received from the high privilege manager or to cause the at least one guest to perform certain activities periodically.

The above example device may be further configured, wherein the processing module is configured to include virtualization technology (VT) and the high privilege execution environment is a system management mode random access memory (SMRAM). In this configuration, the example device may be further configured, wherein the high privilege manager is a system management interrupt transfer monitor (STM), the low privilege manager is a measured launch environment (NILE) and the at least one guest is a system management mode (SMM) guest other than a BIOS SMM guest or a system management interrupt (SMI) SMM guest.

In another example embodiment there is provided a method. The method may include loading at least one guest into a low privilege execution environment, and issuing a command to a high privilege manager in a high privilege execution environment to place the at least one guest into the high privilege execution environment.

The above example method may be further configured, wherein the at least one guest is loaded into the low privilege execution environment from at least one of a BIOS image loaded into the device when activated, another device via a network connection or a data storage component in the device.

The above example method may further comprise interacting with the at least one guest by issuing a command to the high privilege manager.

The above example method may further comprise causing the at least one guest to be removed from the high privilege execution environment by issuing a command to the high privilege manager.

The above example method may be further configured, wherein the high privilege execution environment is a system management mode random access memory (SMRAM), the high privilege manager is a system management interrupt transfer monitor (STM) and the at least one guest is a system management mode (SMM) guest other than a BIOS SMM guest or a system management interrupt (SMI) SMM guest.

In another example embodiment there is presented a method. The method may include initiating operation of at least one guest in a high privilege execution environment, determining whether a first bit is set in the at least one guest, the first bit indicating that an activity performed by the at least one guest should be performed periodically, and configuring the at least one guest to perform the activity based on the determination of whether the first bit is set.

The above example method may be further configured, wherein configuring the at least one guest to perform the activity comprises periodically transmitting commands to the at least one guest if the first bit is determined to be set, the commands instructing the at least one guest to execute.

The above example method may further comprise receiving a command from a low privilege manager, the command instructing to terminate operation of the at least one guest, determining whether a second bit is set in the at least one guest, the second bit indicating to ignore commands received from the low privilege manager to terminate operation of the at least one guest, and continuing or terminating operation of the at least one guest based on the determination of whether the second bit is set. In this configuration, the example method may be further configured, wherein the high privilege execution environment is a system management mode random access memory (SMRAM), the low privilege manager is a measured launch environment (MLE) and the at least one guest is a system management mode (SMM) guest other than a BIOS SMM guest or a system management interrupt (SMI) SMM guest.

In another example embodiment there is provided a system comprising at least a device, the system being arranged to perform any of the above example methods.

In another example embodiment there is provided a chipset arranged to perform any of the above example methods.

In another example embodiment there is provided at least one machine readable medium comprising a plurality of instructions that, in response to be being executed on a computing device, cause the computing device to carry out any of the above example methods.

In another example embodiment there is provided an apparatus configured for isolated guest creation in a virtualized computing system, the apparatus being arranged to perform any of the above example methods.

In another example embodiment there is provided a system comprising at least one machine-readable storage medium having stored thereon, individually or in combination, instructions that when executed by one or more processors result in the system performing any of the above example methods.

In another example embodiment there is provided a device. The device may include a memory module configured to include a high privilege execution environment and a low privilege execution environment, and a processing module configured to execute a low privilege manager for the low privilege execution environment, the low privilege manager being configured to cause a high privilege manager in the high privilege execution environment to place at least one guest into the high privilege execution environment.

The above example device may be further configured, wherein placing the at least one guest comprises the low privilege manager being further configured to initially load the at least one guest into the low privilege execution environment by obtaining the at least one guest from at least one of a BIOS image loaded into the device when activated, another device via a network connection or a data storage component in the memory module. In this configuration, the example device may be further configured, wherein placing the at least one guest comprises the low privilege manager being further configured to issue a command to the high privilege manager to load the at least one guest from the low privilege execution environment into the high privilege execution environment.

The above example device may further comprise the low privilege manager being further configured to interact with the at least one guest by issuing a command to the high privilege manager.

The above example device may further comprise the low privilege manager being further configured to cause the at least one guest to be removed from the high privilege execution environment by issuing a command to the high privilege manager.

The above example device may be further configured, wherein the at least one guest is configured to include a header, body, signature and attributes. In this configuration, the example device may be further configured, wherein the attributes include at least one bit configured to cause the at least one guest to at least one of ignore stop commands received from the high privilege manager or to cause the at least one guest to perform certain activities periodically.

The above example device may be further configured, wherein the processing module is configured to include virtualization technology (VT) and the high privilege execution environment is a system management mode random access memory (SMRAM). In this configuration, the example device may be further configured, wherein the high privilege manager is a system management interrupt transfer monitor (STM), the low privilege manager is a measured launch environment (NILE) and the at least one guest is a system management mode (SMM) guest other than a BIOS SMM guest or a system management interrupt (SMI) SMM guest.

In another example embodiment there is provided a method. The method may include loading at least one guest into a low privilege execution environment, and issuing a command to a high privilege manager in a high privilege execution environment to place the at least one guest into the high privilege execution environment.

The above example method may be further configured, wherein the at least one guest is loaded into the low privilege execution environment from at least one of a BIOS image loaded into the device when activated, another device via a network connection or a data storage component in the device.

The above example method may further comprise interacting with the at least one guest by issuing a command to the high privilege manager.

The above example method may further comprise causing the at least one guest to be removed from the high privilege execution environment by issuing a command to the high privilege manager.

The above example method may be further configured, wherein the high privilege execution environment is a system management mode random access memory (SMRAM), the high privilege manager is a system management interrupt transfer monitor (STM) and the at least one guest is a system management mode (SMM) guest other than a BIOS SMM guest or a system management interrupt (SMI) SMM guest.

In another example embodiment there is presented a method. The method may include initiating operation of at least one guest in a high privilege execution environment, determining whether a first bit is set in the at least one guest, the first bit indicating that an activity performed by the at least one guest should be performed periodically, and configuring the at least one guest to perform the activity based on the determination of whether the first bit is set.

The above example method may be further configured, wherein configuring the at least one guest to perform the activity comprises periodically transmitting commands to the at least one guest if the first bit is determined to be set, the commands instructing the at least one guest to execute.

The above example method may further comprise receiving a command from a low privilege manager, the command instructing to terminate operation of the at least one guest, determining whether a second bit is set in the at least one guest, the second bit indicating to ignore commands received from the low privilege manager to terminate operation of the at least one guest, and continuing or terminating operation of the at least one guest based on the determination of whether the second bit is set. In this configuration, the example method may be further configured, wherein the high privilege execution environment is a system management mode random access memory (SMRAM), the low privilege manager is a measured launch environment (MLE) and the at least one guest is a system management mode (SMM) guest other than a BIOS SMM guest or a system management interrupt (SMI) SMM guest.

In another example embodiment there is provided a system comprising at least one machine-readable storage medium. The machine-readable medium having stored thereon, individually or in combination, instructions that when executed by one or more processors result in the following operations comprising loading at least one guest into a low privilege execution environment, and issuing a command to a high privilege manager in a high privilege execution environment to place the at least one guest into the high privilege execution environment. The above example system may be further configured, wherein the at least one guest is loaded into the low privilege execution environment from at least one of a BIOS image loaded into the device when activated, another device via a network connection or a data storage component in the device.

The above example system may further comprise instructions that when executed by one or more processors result in the following operations comprising interacting with the at least one guest by issuing a command to the high privilege manager.

The above example system may further comprise instructions that when executed by one or more processors result in the following operations comprising causing the at least one guest to be removed from the high privilege execution environment by issuing a command to the high privilege manager.

The above example system may be further configured, wherein the high privilege execution environment is a system management mode random access memory (SMRAM), the high privilege manager is a system management interrupt transfer monitor (STM) and the at least one guest is a system management mode (SMM) guest other than a BIOS SMM guest or a system management interrupt (SMI) SMM guest.

In another example embodiment there is provided a system comprising at least one machine-readable storage medium. The machine-readable medium having stored thereon, individually or in combination, instructions that when executed by one or more processors result in the following operations comprising initiating operation of at least one guest in a high privilege execution environment, determining whether a first bit is set in the at least one guest, the first bit indicating that an activity performed by the at least one guest should be performed periodically, and configuring the at least one guest to perform the activity based on the determination of whether the first bit is set.

The above example system may be further configured, wherein configuring the at least one guest to perform the activity comprises periodically transmitting commands to the at least one guest if the first bit is determined to be set, the commands instructing the at least one guest to execute.

The above example system may further comprise instructions that when executed by one or more processors result in the following operations comprising receiving a command from a low privilege manager, the command instructing to terminate operation of the at least one guest, determining whether a second bit is set in the at least one guest, the second bit indicating to ignore commands received from the low privilege manager to terminate operation of the at least one guest, and continuing or terminating operation of the at least one guest based on the determination of whether the second bit is set. In this configuration the example system may be further configured, wherein the high privilege execution environment is a system management mode random access memory (SMRAM), the low privilege manager is a measured launch environment (MLE) and the at least one guest is a system management mode (SMM) guest other than a BIOS SMM guest or a system management interrupt (SMI) SMM guest.

In another example embodiment there is provided a device. The device may include a memory module configured to include a high privilege execution environment and a low privilege execution environment, and a processing module configured to execute a low privilege manager for the low privilege execution environment, the low privilege manager being configured to cause a high privilege manager in the high privilege execution environment to place at least one guest into the high privilege execution environment.

The above example device may be further configured, wherein placing the at least one guest comprises the low privilege manager being further configured to initially load the at least one guest into the low privilege execution environment by obtaining the at least one guest from at least one of a BIOS image loaded into the device when activated, another device via a network connection or a data storage component in the memory module. In this configuration the example device may be further configured, wherein placing the at least one guest comprises the low privilege manager being further configured to issue a command to the high privilege manager to load the at least one guest from the low privilege execution environment into the high privilege execution environment.

The above example device may further comprise the low privilege manager being further configured to interact with the at least one guest by issuing a command to the high privilege manager, and to cause the at least one guest to be removed from the high privilege execution environment by issuing a command to the high privilege manager.

The above example device may be further configured, wherein the at least one guest is configured to include a header, body, signature and attributes including at least one bit configured to cause the at least one guest to at least one of ignore stop commands received from the high privilege manager or to cause the at least one guest to perform certain activities periodically.

The above example device may be further configured, wherein the processing module is configured to include virtualization technology (VT), the high privilege execution environment is a system management mode random access memory (SMRAM), the high privilege manager is a system management interrupt transfer monitor (STM), the low privilege manager is a measured launch environment (MLE) and the at least one guest is a system management mode (SMM) guest other than a BIOS SMM guest or a system management interrupt (SMI) SMM guest.

In another example embodiment there is provided a method. The method may include loading at least one guest into a low privilege execution environment, and issuing a command to a high privilege manager in a high privilege execution environment to place the at least one guest into the high privilege execution environment.

The above example method may be further configured, wherein the at least one guest is loaded into the low privilege execution environment from at least one of a BIOS image loaded into the device when activated, another device via a network connection or a data storage component in the device.

The above example method may further comprise interacting with the at least one guest by issuing a command to the high privilege manager, and causing the at least one guest to be removed from the high privilege execution environment by issuing a command to the high privilege manager.

In another example embodiment there is provided a method. The method may include initiating operation of at least one guest in a high privilege execution environment, determining whether a first bit is set in the at least one guest, the first bit indicating that an activity performed by the at least one guest should be performed periodically, and configuring the at least one guest to perform the activity based on the determination of whether the first bit is set.

The above example method may be further configured, wherein configuring the at least one guest to perform the activity comprises periodically transmitting commands to the at least one guest if the first bit is determined to be set, the commands instructing the at least one guest to execute.

The above example method may further comprise receiving a command from a low privilege manager, the command instructing to terminate operation of the at least one guest, determining whether a second bit is set in the at least one guest, the second bit indicating to ignore commands received from the low privilege manager to terminate operation of the at least one guest, and continuing or terminating operation of the at least one guest based on the determination of whether the second bit is set.

In another example embodiment there is provided a system comprising at least a device, the system being arranged to perform any of the above example methods.

In another example embodiment there is provided a chipset arranged to perform any of the above example methods.

In another example embodiment there is provided at least one machine readable medium comprising a plurality of instructions that, in response to be being executed on a computing device, cause the computing device to carry out any of the above example methods.

In another example embodiment there is provided a device. The device may include a memory module configured to include a high privilege execution environment and a low privilege execution environment, and a processing module configured to execute a low privilege manager for the low privilege execution environment, the low privilege manager being configured to cause a high privilege manager in the high privilege execution environment to place at least one guest into the high privilege execution environment.

The above example device may be further configured, wherein placing the at least one guest comprises the low privilege manager being further configured to initially load the at least one guest into the low privilege execution environment by obtaining the at least one guest from at least one of a BIOS image loaded into the device when activated, another device via a network connection or a data storage component in the memory module. In this configuration, the example device may be further configured, wherein placing the at least one guest comprises the low privilege manager being further configured to issue a command to the high privilege manager to load the at least one guest from the low privilege execution environment into the high privilege execution environment.

The above example device may further comprise the low privilege manager being further configured to interact with the at least one guest by issuing a command to the high privilege manager.

The above example device may further comprise the low privilege manager being further configured to cause the at least one guest to be removed from the high privilege execution environment by issuing a command to the high privilege manager.

The above example device may be further configured, wherein the at least one guest is configured to include a header, body, signature and attributes. In this configuration, the example device may be further configured, wherein the attributes include at least one bit configured to cause the at least one guest to at least one of ignore stop commands received from the high privilege manager or to cause the at least one guest to perform certain activities periodically.

The above example device may be further configured, wherein the processing module is configured to include virtualization technology (VT) and the high privilege execution environment is a system management mode random access memory (SMRAM). In this configuration, the example device may be further configured, wherein the high privilege manager is a system management interrupt transfer monitor (STM), the low privilege manager is a measured launch environment (NILE) and the at least one guest is a system management mode (SMM) guest other than a BIOS SMM guest or a system management interrupt (SMI) SMM guest.

In another example embodiment there is provided a method. The method may include loading at least one guest into a low privilege execution environment, and issuing a command to a high privilege manager in a high privilege execution environment to place the at least one guest into the high privilege execution environment.

The above example method may be further configured, wherein the at least one guest is loaded into the low privilege execution environment from at least one of a BIOS image loaded into the device when activated, another device via a network connection or a data storage component in the device.

The above example method may further comprise interacting with the at least one guest by issuing a command to the high privilege manager.

The above example method may further comprise causing the at least one guest to be removed from the high privilege execution environment by issuing a command to the high privilege manager.

The above example method may be further configured, wherein the high privilege execution environment is a system management mode random access memory (SMRAM), the high privilege manager is a system management interrupt transfer monitor (STM) and the at least one guest is a system management mode (SMM) guest other than a BIOS SMM guest or a system management interrupt (SMI) SMM guest.

In another example embodiment there is presented a method. The method may include initiating operation of at least one guest in a high privilege execution environment, determining whether a first bit is set in the at least one guest, the first bit indicating that an activity performed by the at least one guest should be performed periodically, and configuring the at least one guest to perform the activity based on the determination of whether the first bit is set.

The above example method may be further configured, wherein configuring the at least one guest to perform the activity comprises periodically transmitting commands to the at least one guest if the first bit is determined to be set, the commands instructing the at least one guest to execute.

The above example method may further comprise receiving a command from a low privilege manager, the command instructing to terminate operation of the at least one guest, determining whether a second bit is set in the at least one guest, the second bit indicating to ignore commands received from the low privilege manager to terminate operation of the at least one guest, and continuing or terminating operation of the at least one guest based on the determination of whether the second bit is set. In this configuration, the example method may be further configured, wherein the high privilege execution environment is a system management mode random access memory (SMRAM), the low privilege manager is a measured launch environment (MLE) and the at least one guest is a system management mode (SMM) guest other than a BIOS SMM guest or a system management interrupt (SMI) SMM guest.

In another example embodiment there is provided a system. The system may include means for loading at least one guest into a low privilege execution environment, and means for issuing a command to a high privilege manager in a high privilege execution environment to place the at least one guest into the high privilege execution environment.

The above example system may be further configured, wherein the at least one guest is loaded into the low privilege execution environment from at least one of a BIOS image loaded into the device when activated, another device via a network connection or a data storage component in the device.

The above example system may further comprise means for interacting with the at least one guest by issuing a command to the high privilege manager.

The above example system may further comprise means for causing the at least one guest to be removed from the high privilege execution environment by issuing a command to the high privilege manager.

The above example system may be further configured, wherein the high privilege execution environment is a system management mode random access memory (SMRAM), the high privilege manager is a system management interrupt transfer monitor (STM) and the at least one guest is a system management mode (SMM) guest other than a BIOS SMM guest or a system management interrupt (SMI) SMM guest.

In another example embodiment there is provided a system. The system may include means for initiating operation of at least one guest in a high privilege execution environment, means for determining whether a first bit is set in the at least one guest, the first bit indicating that an activity performed by the at least one guest should be performed periodically, and means for configuring the at least one guest to perform the activity based on the determination of whether the first bit is set.

The above example system may be further configured, wherein configuring the at least one guest to perform the activity comprises periodically transmitting commands to the at least one guest if the first bit is determined to be set, the commands instructing the at least one guest to execute.

The above example system may further comprise means for receiving a command from a low privilege manager, the command instructing to terminate operation of the at least one guest, means for determining whether a second bit is set in the at least one guest, the second bit indicating to ignore commands received from the low privilege manager to terminate operation of the at least one guest, and means for continuing or terminating operation of the at least one guest based on the determination of whether the second bit is set. In this configuration, the example system may be further configured, wherein the high privilege execution environment is a system management mode random access memory (SMRAM), the low privilege manager is a measured launch environment (NILE) and the at least one guest is a system management mode (SMM) guest other than a BIOS SMM guest or a system management interrupt (SMI) SMM guest.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-22. (canceled)

23. A device, comprising:
a memory module configured to include a high privilege execution environment and a low privilege execution environment; and
a processing module configured to execute a low privilege manager for the low privilege execution environment, the low privilege manager being configured to cause a high privilege manager in the high privilege execution environment to place at least one guest into the high privilege execution environment.

24. The device of claim 23, wherein placing the at least one guest comprises the low privilege manager being further configured to initially load the at least one guest into the low privilege execution environment by obtaining the at least one guest from at least one of a BIOS image loaded into the device when activated, another device via a network connection or a data storage component in the memory module.

25. The device of claim 24, wherein placing the at least one guest comprises the low privilege manager being further configured to issue a command to the high privilege manager to load the at least one guest from the low privilege execution environment into the high privilege execution environment.

26. The device of claim 23, further comprising the low privilege manager being further configured to interact with the at least one guest by issuing a command to the high privilege manager.

27. The device of claim 23, further comprising the low privilege manager being further configured to cause the at least one guest to be removed from the high privilege execution environment by issuing a command to the high privilege manager.

28. The device of claim 23, wherein the at least one guest is configured to include a header, body, signature and attributes.

29. The device of claim 28, wherein the attributes include at least one bit configured to cause the at least one guest to at least one of ignore stop commands received from the high privilege manager or to cause the at least one guest to perform certain activities periodically.

30. The device of claim 23, wherein the processing module is configured to include virtualization technology (VT) and the high privilege execution environment is a system management mode random access memory (SMRAM).

31. The device of claim 30, wherein the high privilege manager is a system management interrupt transfer monitor (STM), the low privilege manager is a measured launch environment (MLE) and the at least one guest is a system management mode (SMM) guest other than a BIOS SMM guest or a system management interrupt (SMI) SMM guest.

32. A method, comprising:
loading at least one guest into a low privilege execution environment; and
issuing a command to a high privilege manager in a high privilege execution environment to place the at least one guest into the high privilege execution environment.

33. The method of claim 32, wherein the at least one guest is loaded into the low privilege execution environment from at least one of a BIOS image loaded into the device when activated, another device via a network connection or a data storage component in the device.

34. The method of claim 32, further comprising interacting with the at least one guest by issuing a command to the high privilege manager.

35. The method of claim 32, further comprising causing the at least one guest to be removed from the high privilege execution environment by issuing a command to the high privilege manager.

36. The method of claim 32, wherein the high privilege execution environment is a system management mode random access memory (SMRAM), the high privilege manager is a system management interrupt transfer monitor (STM) and the at least one guest is a system management mode (SMM) guest other than a BIOS SMM guest or a system management interrupt (SMI) SMM guest.

37. A method comprising:
initiating operation of at least one guest in a high privilege execution environment;
determining whether a first bit is set in the at least one guest, the first bit indicating that an activity performed by the at least one guest should be performed periodically; and
configuring the at least one guest to perform the activity based on the determination of whether the first bit is set.

38. The method of claim 37, wherein configuring the at least one guest to perform the activity comprises periodically transmitting commands to the at least one guest if the first bit is determined to be set, the commands instructing the at least one guest to execute.

39. The method of claim 37, further comprising:
receiving a command from a low privilege manager, the command instructing to terminate operation of the at least one guest;
determining whether a second bit is set in the at least one guest, the second bit indicating to ignore commands received from the low privilege manager to terminate operation of the at least one guest; and
continuing or terminating operation of the at least one guest based on the determination of whether the second bit is set.

40. The method of claim 39, wherein the high privilege execution environment is a system management mode random access memory (SMRAM), the low privilege manager is a measured launch environment (MLE) and the at least one guest is a system management mode (SMM) guest other than a BIOS SMM guest or a system management interrupt (SMI) SMM guest.

41. A system comprising at least one machine-readable storage medium having stored thereon, individually or in combination, instructions that when executed by one or more processors result in the following operations comprising:
loading at least one guest into a low privilege execution environment; and
issuing a command to a high privilege manager in a high privilege execution environment to place the at least one guest into the high privilege execution environment.

42. The system of claim 41, wherein the at least one guest is loaded into the low privilege execution environment from at least one of a BIOS image loaded into the device when activated, another device via a network connection or a data storage component in the device.

43. The system of claim 41, further comprising instructions that when executed by one or more processors result in the following operations comprising:
interacting with the at least one guest by issuing a command to the high privilege manager.

44. The system of claim 41, further comprising instructions that when executed by one or more processors result in the following operations comprising:
causing the at least one guest to be removed from the high privilege execution environment by issuing a command to the high privilege manager.

45. The system of claim 41, wherein the high privilege execution environment is a system management mode random access memory (SMRAM), the high privilege manager is a system management interrupt transfer monitor (STM) and the at least one guest is a system management mode (SMM) guest other than a BIOS SMM guest or a system management interrupt (SMI) SMM guest.

46. A system comprising at least one machine-readable storage medium having stored thereon, individually or in combination, instructions that when executed by one or more processors result in the following operations comprising:
initiating operation of at least one guest in a high privilege execution environment;
determining whether a first bit is set in the at least one guest, the first bit indicating that an activity performed by the at least one guest should be performed periodically; and
configuring the at least one guest to perform the activity based on the determination of whether the first bit is set.

47. The system of claim 46, wherein configuring the at least one guest to perform the activity comprises periodically transmitting commands to the at least one guest if the first bit is determined to be set, the commands instructing the at least one guest to execute.

48. The system of claim 46, further comprising instructions that when executed by one or more processors result in the following operations comprising:
receiving a command from a low privilege manager, the command instructing to terminate operation of the at least one guest;
determining whether a second bit is set in the at least one guest, the second bit indicating to ignore commands received from the low privilege manager to terminate operation of the at least one guest; and
continuing or terminating operation of the at least one guest based on the determination of whether the second bit is set.

49. The system of claim 48, wherein the high privilege execution environment is a system management mode random access memory (SMRAM), the low privilege manager is a measured launch environment (MLE) and the at least one guest is a system management mode (SMM) guest other than a BIOS SMM guest or a system management interrupt (SMI) SMM guest.
